(19) United States
(12) Patent Application Publication
(10) Pub. No.: US 2009/0312218 A1
(43) Pub. Date: Dec. 17, 2009

(54) Detergent or Cleaning Agent Portion

(75) Inventors: Wolfgang Barthel, Langenfeld (DE); Salvatore Fileccla, Oberhausen (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/483,541

(22) Filed: Jun. 12, 2009

Related U.S. Application Data
(63) Continuation of application No. PCT/EP2007/063207, filed on Dec. 4, 2007.

(30) Foreign Application Priority Data
Dec. 13, 2006 (DE) 10 2006 059 271.9

(51) Int. Cl. C11D 17/00

(52) U.S. Cl. 510/221; 510/406; 8/159; 510/277

(57) ABSTRACT

A detergent and cleaning agent portion, comprising a) a first metering unit with a completely closed, water-soluble container of a transparent or translucent polymeric material and a first detergent or cleaning agent preparation which is enclosed in the container, which is liquid, and which occupies up to 99% by volume of the container capacity, the container furthermore containing a gas which is under a pressure of at least 1.02 bar and which occupies at least 1% by volume of the container capacity; and b) a second water-soluble metering unit which is different from the first and which contains a second detergent or cleaning agent preparation.

### CROSS REFERENCE TO RELATED APPLICATIONS

The application is a continuation under 35 U.S.C. §§ 120 and 365(c) of International Application PCT/EP2007/063207, filed on Dec. 4, 2007. This application also claims priority under 35 U.S.C. § 119 of DE 10 2006 059 271.9, filed on Dec. 13, 2006. The disclosures of PCT/EP2007/063207 and DE 10 2006 059 271.9 are incorporated herein by reference in their entirety.

### BACKGROUND OF THE INVENTION

The present invention is in the field of portion packs for detergents or cleaning agents as are for example used for cleaning textiles or hard surfaces such as crockery.

Today, detergents or cleaning agents are offered for sale to consumers in many and varied presentations. In addition to washing powders and granules, the products on offer include, for example, detergent or cleaning agent concentrates in the form of portioned compositions, for example assuming extruded or tableted form. These solid, concentrated or compressed presentations are distinguished by a reduced volume per portion and so result in reduced packaging and transport costs. Detergent or cleaning agent tablets in particular additionally satisfy consumer demand for simple dosing. Corresponding agents are thoroughly described in the prior art. However, in addition to the stated advantages, compacted detergents or cleaning agents also exhibit a series of disadvantages. In particular, due to their elevated compaction, tableted presentations are frequently distinguished by delayed disintegration and thus delayed release of their ingredients. The patent literature discloses numerous technical solutions for resolving this “conflict” between sufficient tablet hardness and short disintegration times, it being possible in this connection to make reference by way of example to the use of “tablet disintegrants”. These disintegration accelerators are added to the tablets in addition to the substances with a detergent or cleaning action. Since the disintegration accelerators do not themselves generally exhibit a detergent or cleaning action, using them increases the complexity and costs of corresponding tablets. A further disadvantage of tableting active substance mixtures, in particular mixtures containing substances with a detergent or cleaning action, is that it may inactivate the active substances present due to the compaction pressure prevailing during tableting. Active substances may also be inactivated by chemical reaction due to an enlargement of ingredient contact surfaces brought about by tableting. On the other hand, tableting active substance mixtures is a technically simple, mature and inexpensive process.

As an alternative to the above-described particulate or compacted detergents or cleaning agents, in recent years solid or liquid detergents or cleaning agents have increasingly been described which comprise water-soluble or water-dispersible packaging. Like tablets, these agents are distinguished by simplified dosing since they can be dosed into the washing machine or dishwashing machine together with the outer packaging, while on the other hand they simultaneously make it possible to formulate liquid or pulverulent detergents or cleaning agents which are distinguished by better dissolution and more rapid activity in comparison with compacted products.

EP 1314654 A2, for example, accordingly discloses a dome-shaped container with a compartment containing a liquid.

International application WO 01/83657 A2 provides multicompartment pouches containing a solid in one compartment and a liquid in another compartment.

European application EP 1256623 A1 provides a kit comprising at least two pouches of differing composition and differing visual properties. The pouches are separate from one another and do not assume the form of a compact individual product.

Application DE 10244802 describes a method for producing entirely or partially Water-soluble filled hollow articles, in which the hollow article is initially filled with an agent, for example a detergent or cleaning agent. Before the hollow article is sealed, it is additionally filled with a chilled gas. The resultant hollow articles are intended to appear firmly filled and so, in contrast to slack looking pouches, have an advantageous appearance and good mechanical stability.

Detergent or cleaning agent portions are intended simultaneously to meet a plurality of different requirements. Apart from mechanical stability, good handleability and attractive product appearance, these in particular include ensuring elevated product performance under various cleaning conditions and elevated flexibility with regard to different presentations for the manufacturers and suppliers of such products. Despite the wide variety of technical solutions described in the prior art, these are not yet satisfactory in every respect.

Furthermore, investigations by the applicant have revealed that, in the field of detergents and cleaning agents, consumers associate the presence of a liquid phase with elevated product performance. A consumer's decision to purchase such an agent may thus be positively influenced if he/she can immediately tell from the external appearance of the agent that it contains a liquid.

### DESCRIPTION OF THE INVENTION

The object of the present invention is accordingly to provide portioned detergent or cleaning agents which not only exhibit good performance in use and are mechanically stable during production, processing, storage and transport, but moreover have an attractive visual appearance which the purchaser or user associates with elevated cleaning performance. The agents should furthermore be as simple and inexpensive as possible to produce. They should furthermore provide the manufacturer and supplier of such agents with elevated flexibility in the individual development of the agents and permit a plurality of different presentations.

It has now been found that this object may be achieved by the subject matter of the invention as stated in the claims.

The present invention accordingly provides a detergent or cleaning agent portion comprising
a) a first dosing unit comprising a completely sealed water-soluble container of a transparent or translucent polymeric material and, enclosed in the container, a first detergent or cleaning agent preparation which is liquid and occupies up to 99 vol. % of the container's volume, the container furthermore containing a gas under a pressure of at least 1.02 bar which occupies at least 1 vol. % of the container's volume, and
b) a second water-soluble dosing unit, different from the first, comprising a second detergent or cleaning agent preparation.

The first dosing unit of the detergent or cleaning agent portions according to the invention comprises a container which contains a gas bubble visible through the container wall. This gas bubble is mobile in the liquid contained in the container when the spatial position of the container or of the entire portion is changed. The gas bubble accordingly provides an observer with a visual indication that the container contains a liquid.

Under the conditions of production, storage, supply and use conventional for such detergent or cleaning agent portions, the container of the first dosing unit is under an overpressure relative to its surroundings. Because it is filled with the gas under overpressure and despite being only partially filled with liquid, the container acquires good mechanical stability and simultaneously an attractive appearance. Without this overpressure, comparably good mechanical stability and a comparably attractive appearance could for example only be achieved if the wall thickness of the container were distinctly greater than is necessary in the case of the container according to the invention. However, this would not only make production more complicated and costly, it would also result, when putting the portions to their intended use, in distinct disadvantages and restrictions with regard to the potential uses of such portions due to the lower dissolution rate of the container wall. The detergent or cleaning agent portions according to the invention thus permit good mechanical stability and an attractive appearance while simultaneously being easier and less expensive to produce.

In preferred embodiments of detergent or cleaning agent portions according to the invention, the role of the first dosing unit is, when used in a washing or cleaning method, to release a first detergent or cleaning agent preparation at an early point in time and/or already at a low temperature, in particular at the conventional temperature of cold tap water. This release process is promoted in the portions according to the invention by the container of the first dosing unit being under an overpressure. As a result, on contact with the washing or cleaning liquor, the container wall opens or bursts more rapidly, so resulting in the desired earlier release of the container's contents.

It is preferred according to the invention for the container of the first dosing unit to contain a gas which is under a pressure of at least 1.05 bar and in particular of at least 1.1 bar. It is further preferred for the upper limit of the pressure to be at 2 bar and in particular at 1.5 bar.

For the purposes of the present invention, a gas is in particular a substance which assumes the gaseous state of matter in a temperature range from 10 to 40° C. and under a pressure of 1 to 2 bar. The gas is preferably selected from air, nitrogen, carbon dioxide, noble gases and mixtures thereof, in particular of air and/or nitrogen.

In a preferred embodiment of the invention, the polymeric material which forms the container and in particular the container wall of the first dosing unit of the detergent or cleaning agent portion is a thermoplastic material. It is particularly preferred for the polymeric material to comprise a polyvinyl alcohol. In one particularly preferred embodiment, the container of the first dosing unit consists entirely of a polyvinyl alcohol or a mixture of different polyvinyl alcohols.

The polymeric material used may comprise single layer or multilayer films (for example laminated films). The water content of the films preferably amounts to below 10 wt. %, particularly preferably below 7 wt. %, very particularly preferably below 5 wt. % and in particular below 4 wt. %. The container may, of course, also consist of two different polymeric materials which are joined to the container for example along a peripheral sealed or pinch-off seam. The materials may differ in this case for example with regard to the chemical nature or proportion by weight of the water-soluble polymers used, or indeed with regard to the chemical nature or proportions by weight of any additives such as stabilizers or dyes. For the purposes of the present invention, embodiments are also feasible in which the container of the first dosing unit comprises two polymeric film materials, which differ with regard to their dye content, i.e. are differently colored, it being possible for the two polymeric film materials to be joined together for example along a peripheral sealed or pinch-off seam.

A series of different water-soluble polymers are suitable as the basis for the polymeric material. Some particularly preferred water-soluble or water-dispersible polymers are listed below. Water-soluble polymers for the purposes of the invention are those polymers which are more than 2.5 wt. % soluble in water at 20° C. The stated polymers may in this case be used both on their own and in combination with one another or in combination with further substances, for example plasticizers or solubilizing agents.

Particularly preferred water-soluble or water-dispersible polymers comprise the
a) water-soluble nonionic polymers from the group comprising
a1) polyvinylpyrrolidones,
a2) vinylpyrrolidone/vinyl ester copolymers,
a3) cellulose ethers
b) water-soluble amphoteric polymers from the group comprising
b1) alkylacrylamide/acrylic acid copolymers
b2) alkylacrylamide/methacrylic acid copolymers
b3) alkylacrylamide/methyl methacrylic acid copolymers
b4) alkylacrylamide/acrylic acid/alkylaminoalkyl (meth)acrylic acid copolymers
b5) alkylacrylamide/methacrylic acid/alkylaminoalkyl (meth)acrylic acid copolymers
b6) alkylacrylamide/methyl methacrylic acid/alkylaminoalkyl (meth)acrylic acid copolymers
b7) alkylacrylamide/alkyl methacrylate/alkylaminoethyl methacrylate/alkyl methacrylate copolymers
b8) copolymers of
   b8i) unsaturated carboxylic acids
   b8ii) cationically derivatized unsaturated carboxylic acids
   b8iii) optionally further ionic or nonionogenic monomers
c) water-soluble zwitterionic polymers from the group comprising
c1) acrylamidoalkyl trialkylammonium chloride/acrylic acid copolymers and the alkali metal and ammonium salts thereof
c2) acrylamidoalkyl trialkylammonium chloride/methacrylic acid copolymers and the alkali metal and ammonium salts thereof
c3) methacryloyl ethyl betaine/methacrylate copolymers
d) water-soluble anionic polymers from the group comprising
d1) vinyl acetate/crotonic acid copolymers
d2) vinylpyrrolidone/vinyl acrylate copolymers
d3) acrylic acid/ethyl acrylate/N-tert.-butylacrylamide terpolymers
d4) graft polymers of vinyl esters, esters of acrylic acid or methacrylic acid alone or as a mixture, copolymerized with crotonic acid, acrylic acid or methacrylic acid with polyalkylene oxides and/or polyalkylene glycols
d5) grafted and crosslinked copolymers from the copolymerization of
   d5i) at least one monomer of the nonionic type,
   d5ii) at least one monomer of the ionic type,
   d5iii) of polyethylene glycol and
   d5iv) a crosslinking agent
d6) copolymers obtained by copolymerization of at least one monomer from each of the following three groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of carboxylic acids from group d6ii) with saturated or unsaturated straight-chain or branched C₈₋₁₈ alcohols
d7) terpolymers of crotonic acid, vinyl acetate and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters or straight-chain allyl or methallyl esters
d9) crotonic acid copolymers with one or more monomers from the group ethylene, vinylbenzene, vinyl methyl ether, acrylamide and the water-soluble salts thereof
d10) terpolymers of vinyl acetate, crotonic acid and vinyl esters of a saturated aliphatic monocarboxylic acid branched in α-position
e) water-soluble cationic polymers from the group comprising
e1) quaternized cellulose derivatives
e2) polysiloxanes with quaternary groups,
e3) cationic guar derivatives
e4) polymeric dimethyldiallylammonium salts and the copolymers thereof with esters and amides of acrylic acid and methacrylic acid
e5) copolymers of vinylpyrrolidone with quaternized derivatives of dialkylamino acrylate and methacrylate
e6) vinylpyrrolidone/methoimidazolinium chloride copolymers
e7) quaternized polyvinyl alcohol,
e8) polymers known by the INCI names Polyquaternium 2, Polyquaternium 17, Polyquaternium 18 and Polyquaternium 27.

In one particularly preferred embodiment, the polymeric material comprises at least a proportion of a substance, optionally in acetalized form, from the group comprising polyvinyl alcohols, polyvinylpyrrolidones, polyethylene oxides, gelatin, cellulose or the derivatives thereof.

“Polyvinyl alcohols” (abbreviated PVAL, occasionally also PVOH) is the name given to polymers of the general structure

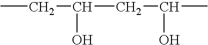

which also comprise small proportions (approx. 2%) of structural units of the type

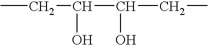

Conventional commercial polyvinyl alcohols, which are offered for sale as white-yellowish powder or granules with degrees of polymerization in the range from approx. 100 to 2500 (molar masses of approx. 4000 to 100,000 g/mol), have degrees of hydrolysis of 98-99 or 87-89 mol %, and thus still have a residual content of acetyl groups. Manufacturers differentiate polyvinyl alcohols by stating the degree of polymerization of the starting polymer, the degree of hydrolysis, the saponification value or the solution viscosity.

Depending on their degree of hydrolysis, polyvinyl alcohols are soluble in water and less strongly polar organic solvents (formamide, dimethylformamide, dimethyl sulfoxide); they are not attacked by (chlorinated) hydrocarbons, esters, fats and oils. Polyvinyl alcohols are classed as toxicologically safe and are at least partially biodegradable. Water solubility may be reduced by post-treatment with aldehydes (acetalization). Polyvinyl alcohols which are respectively acetalized or ketalized with the aldehyde or keto groups of saccharides or polysaccharides or mixtures thereof have proved to be particularly preferred and particularly advantageous due to their markedly good cold water solubility. The reaction products of PVAL and starch may extremely advantageously be used.

Water solubility may furthermore be modified by complexation with Ni or Cu salts or by treatment with dichromates, boric acid, borax and so purposefully be adjusted to desired values. PVAL films are largely impenetrable by gases such as oxygen, nitrogen, helium, hydrogen, carbon dioxide, but do allow water vapor to pass through.

For the purposes of the present invention, it is preferred for the polymeric material to comprise at least a proportion of a polyvinyl alcohol having a degree of hydrolysis of 70 to 100 mol %, preferably of 80 to 90 mol %, particularly preferably of 81 to 89 mol % and in particular of 82 to 88 mol %. In a preferred embodiment, the polymeric material consists to an extent of at least 20 wt. %, particularly preferably of at least 40 wt. %, very particularly preferably of at least 60 wt. % and in particular of at least 80 wt. % of a polyvinyl alcohol having a degree of hydrolysis of 70 to 100 mol %, preferably of 80 to 90 mol %, particularly preferably of 81 to 89 mol % and in particular of 82 to 88 mol %.

The polymeric material preferably comprises polyvinyl alcohols of a specific molecular weight range, it being preferred according to the invention for the material to comprise a polyvinyl alcohol having a molecular weight in the range from 10,000 to 100,000 gmol⁻¹, preferably of 11,000 to 90,000 gmol⁻¹, particularly preferably of 12,000 to 80,000 gmol⁻¹ and in particular of 13,000 to 70,000 gmol⁻¹.

The degree of polymerization of such preferred polyvinyl alcohols is between approx. 200 to approx. 2100, preferably between approx. 220 to approx. 1890, particularly preferably between approx. 240 to approx. 1680 and in particular between approx. 260 to approx. 1500.

The above-described polyvinyl alcohols are widely commercially available, for example under the trademark Mowiol® (Clariant). Polyvinyl alcohols which are particularly suitable for the purposes of the present invention are for example Mowiol® 3-83, Mowiol® 4-88, Mowiol® 5-88 and Mowiol® 8-88.

Further polyvinyl alcohols which are particularly suitable as a material for the container can be found in the table below:

| | Degree of | Molar mass | Melting point |
|---|---|---|---|
| Name | hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Further polyvinyl alcohols suitable as polymeric material are ELVANOL® 51-05, 52-22, 50-42, 85-82, 75-15, T-25, T-66, 90-50 (trademarks of DuPont), ALCOTEX® 72.5, 78, B72, F80/40, F88/4, F88/26, F88/40, F88/47 (trademarks of Harlow Chemical Co.), Gohsenol® NC-05, A-300, AH-22, C-500, GH-20, GL-03, GM-14L, KA-20, KA-500, KH-20, KP-06, N-300, NH-26, NM11Q, KZ-06 (trademarks of Nippon Gohsei K.K.).

Examples of suitable water-soluble PVAL films are the PVAL films obtainable under the name “SOLUBLON®” from Syntana Handelsgesellschaft E. Harke GmbH & Co. Their solubility in water can be accurately adjusted to a specific temperature and films from this product range are available which are soluble in an aqueous phase in all applicationally relevant temperature ranges.

Polyvinylpyrrolidones, abbreviated PVP, may be described by the following general formula:

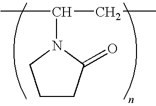

PVPs are produced by free-radical polymerization of 1-vinylpyrrolidone. Conventional commercial PVPs have molar masses in the range from approx. 2,500 to 750,000 g/mol and are offered for sale as white, hygroscopic powders or as aqueous solutions.

Polyethylene oxides, abbreviated PEOX, are polyalkylene glycols of the general formula

H—[O—CH₂—CH₂]ₙ—OH

which are produced industrially by base-catalyzed polyaddition of ethylene oxide (oxirane) in systems usually containing small quantities of water with ethylene glycol as the starter molecule. They have molar masses in the range from approx. 200 to 5,000,000 g/mol, corresponding to degrees of polymerization n of approx. 5 to >100,000. Polyethylene oxides have an extremely low concentration of reactive hydroxy end groups and exhibit only slight residual glycol properties.

It is likewise possible according to the invention to use polymeric materials which comprise a polymer from the group comprising starch and starch derivatives, cellulose and cellulose derivatives, in particular methylcellulose and mixtures thereof.

The portions according to the invention are characterized in that the polymeric material of the container of the first dosing unit is transparent or translucent.

For the purposes of the present invention, transparency should be taken to mean that transmittance within the visible spectrum of light (410 to 800 nm) is greater than 20%, preferably greater than 30%, extremely preferably greater than 40% and in particular greater than 50%. Accordingly, once a wavelength of the visible spectrum of light exhibits transmittance of greater than 20%, it should be deemed transparent for the purposes of the invention.

Containers produced according to the invention, the production of which involved use of a transparent material, may contain a stabilizer. For the purposes of the invention, stabilizers are materials which protect the ingredients present in the compartment from decomposition or inactivation by exposure to light. Antioxidants, UV absorbers and fluorescent dyes have proved particularly suitable in this connection.

Preferred detergent or cleaning agent portions are characterized in that the polymeric material forming the container wall has a thickness of between 5 and 800 μm, preferably between 50 and 700 μm, and in particular between 100 and 600 μm.

In one particular embodiment of the invention, the polymeric material forming the container wall is thicker in a first subzone of the container surface than in a second subzone. In this way it is possible to ensure that one subzone exhibits elevated mechanical stability, for example in order to join the container by means of this subzone to the second dosing unit, while at the same time another subzone exhibits a higher dissolution rate during use of the portion.

In a preferred embodiment of the invention, the container is blow molded and in particular extrusion blow molded.

The container of the first dosing unit of the portion according to the invention may comprise a peripheral sealed or pinch-off seam.

A peripheral seam is taken to mean a seam which runs continuously over the surface of the container. In a rotationally symmetrical container, for example a spherical container, this seam preferably describes a circle. The size of the circle may here vary in a given container. In a first embodiment, the peripheral seam corresponds to a great circle, thus the largest possible circle on the surface of the container.

However, for the purposes of the present invention, preferred peripheral sealed or pinch-off seams are those which describe a minor circle, thus a circle on the surface of a rotationally symmetrical, for example spherical, container, the plane of which does not contain the center point of the container. A section at the minor circle consequently subdivides the spherical container into two parts of different sizes. Dosing units comprising a sealed or pinch-off seam which subdivides the container into two parts of different sizes may simply be differentiated with regard to the two parts separated by the seam. This may for example be advantageous during subsequent processing or packaging.

The sealed or pinch-off seam may be produced by a range of different methods. Preferred containers are those in which sealing of the polymeric material was brought about by the action of adhesives and/or solvents and/or compressive or pinching forces.

In a further embodiment of the invention, the containers comprise a heat-sealed seam. A range of different tools and methods are available to a person skilled in the art for heat sealing, with preferred sealed seams being those which were produced by the action of heated sealing tools, by the action of a laser beam and/or by the action of hot air.

In one embodiment of dosing units according to the invention, in particular if the sealed or pinch-off seam could be visually troublesome when looking at the portion, it may be preferable for the seam to have the smallest possible width.

In another embodiment of dosing units according to the invention, in particular if the sealed or pinch-off seam is not visually apparent, it may be preferable for the sealed or pinch-off seam to have a width of an order of magnitude of a few millimeters.

In a preferred embodiment of the invention, the sealed or pinch-off seam has a width of less than 3 mm, preferably of less than 2 mm and in particular of less than 1 mm.

It is particularly preferred according to the invention for the sealed or pinch-off seam to subdivide the surface of the container in two subareas of different sizes.

The liquid detergent or cleaning agent preparation contained in the first dosing unit of the detergent or cleaning agent portion according to the invention preferably occupies 50 to 95, particularly preferably 60 to 90 and in particular 65 to 85 vol. % of the container's volume. The details stated in the present application regarding relative vol. % values should be taken to mean values which are measured at 20° C. and 1.013 bar ambient pressure and which relate to the total volume of the container.

The gas contained in the first dosing unit of the detergent or cleaning agent portion according to the invention preferably occupies 5 to 50, particularly preferably 10 to 40 and in particular 15 to 35 vol. % of the container's volume.

In addition to the first liquid detergent or cleaning agent preparation and the gas, the container may additionally contain, for example, a solid which may optionally assume particulate form.

The volume of the container may vary within relevant limits for use as a dosing unit for detergents or cleaning agents, preferred dosing units being those in which the container has a capacity of between 0.3 and 50 ml, preferably between 0.4 and 30 ml and in particular between 0.5 and 20 ml.

The liquid detergent or cleaning agent preparation contained in the first dosing unit of the detergent or cleaning agent portion according to the invention contains at least one surfactant and in particular at least one nonionic surfactant.

Nonionic surfactants which may be considered are in principle any nonionic surfactants known to a person skilled in the art. Examples of suitable nonionic surfactants are alkyl glycosides of the general formula RO(G)ₓ, in which R corresponds to a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose. The degree of oligomerization x, which indicates the distribution of monoglycosides and oligoglycosides, is any desired number between 1 and 10; x is preferably 1.2 to 1.4.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Nonionic surfactants of the amine oxide type, for example N-coconut alkyl-N,N-dimethylamine oxide and N-tallow alcohol-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof.

Further suitable surfactants are polyhydroxyfatty acid amides of the formula,

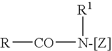

in which R denotes an aliphatic acyl residue with 6 to 22 carbon atoms, R¹ denotes hydrogen, an alkyl or hydroxyalkyl residue with 1 to 4 carbon atoms and [Z] denotes a linear or branched polyhydroxyalkyl residue with 3 to 10 carbon atoms and 3 to 10 hydroxyl groups. The polyhydroxyfatty acid amides comprise known substances which may conventionally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds of the formula

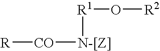

in which R denotes a linear or branched alkyl or alkenyl residue with 7 to 12 carbon atoms, R¹ denotes a linear, branched or cyclic alkyl residue or an aryl residue with 2 to 8 carbon atoms and R² denotes a linear, branched or cyclic alkyl residue or an aryl residue or an oxyalkyl residue with 1 to 8 carbon atoms, C₁₋₄ alkyl or phenyl residues being preferred, and [Z] denotes a linear polyhydroxyalkyl residue, the alkyl chain of which is substituted with at least two hydroxyl groups, or alkoxylated, preferably ethoxylated or propoxylated derivatives of this residue.

[Z] is preferably obtained by reductive amination of a reduced sugar, for example glucose, fructose, maltose, lactose, galactose, mannose or xylose. The N-alkoxy- or N-aryloxy-substituted compounds may be converted into the desired polyhydroxyfatty acid amides by reaction with fatty acid methyl esters in the presence of an alkoxide as catalyst.

Low-foaming nonionic surfactants are used as preferred surfactants. Washing or cleaning preparations, in particular cleaning preparations for machine dishwashing, particularly preferentially contain nonionic surfactants from the group comprising alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Ethoxylated nonionic surfactants which were obtained from C₆₋₂₀ monohydroxyalkanols or C₆₋₂₀ alkylphenols or C16-20 fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₋₈ alcohol, and at least 12 mol, preferably at least 15 mol and in particular at least 20 mol of ethylene oxide. Among these, “narrow range ethoxylates” are particularly preferred.

Combinations of one or more tallow fatty alcohols with 20 to 30 EO and silicone defoamers are particularly preferentially used.

In particular, nonionic surfactants having a melting point of above room temperature are preferred. Nonionic surfactant(s) with a melting point of above of 20° C., preferably of above 25° C., particularly preferably of between 25 and 60° C. and in particular of between 26.6 and 43.3° C., is/are particularly preferred.

Suitable nonionic surfactants which have melting or softening points in the stated temperature range are for example low-foaming nonionic surfactants which may be solid or highly viscous at room temperature. If nonionic surfactants which are highly viscous at room temperature are used, it is preferred for them to have a viscosity of above 20 Pa·s, preferably of above 35 Pa·s and in particular of above 40 Pa·s. Depending on their intended application, nonionic surfactants which have a waxy consistency at room temperature are also preferred.

Nonionic surfactants from the group comprising alkoxylated alcohols, particularly preferably from the group comprising mixed alkoxylated alcohols and in particular from the group comprising EO-AO-EO nonionic surfactants, are likewise particularly preferentially used.

The nonionic surfactant which is solid at room temperature preferably comprises propylene oxide units in its molecule. Such PO units preferably constitute up to 25 wt. %, particularly preferably up to 20 wt. % and in particular up to 15 wt. % of the entire molar mass of the nonionic surfactant. Particularly preferred nonionic surfactants are ethoxylated monohydroxyalkanols or alkylphenols which additionally comprise polyoxyethylene/polyoxypropylene block copolymer units. The alcohol or alkylphenol moiety of such nonionic surfactant molecules here preferably constitutes more than 30 wt. %, particularly preferably more than 50 wt. % and in particular more than 70 wt. % of the entire molar mass of such nonionic surfactants. Preferred agents are characterized in that they contain ethoxylated and propoxylated nonionic surfactants, in which the propylene oxide units constitute in each molecule up to 25 wt. %, preferably up to 20 wt. % and in particular up to 15 wt. % of the entire molar mass of the nonionic surfactant.

Preferably used nonionic surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably to be used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants which have proved to be particularly preferred for the purposes of the present invention are low-foaming nonionic surfactants which comprise alternating ethylene oxide and alkylene oxide units. Among these, surfactants with EO-AO-EO-AO blocks are in turn preferred, with in each case one to ten EO or AO groups being attached to one another before being followed by a block of the respective other groups. Preferred nonionic surfactants are those of the general formula

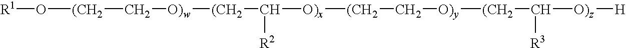

in which R¹ denotes a straight-chain or branched, saturated or mono- or polyunsaturated C₆₋₂₄ alkyl or alkenyl residue; each group R² or R³ is mutually independently selected from —CH₃, —CH₂CH₃, —CH₂CH₂—CH₃, CH(CH₃)₂ and the indices w, x, y, z mutually independently denote integers from 1 to 6.

The preferred nonionic surfactants of the above formula may be produced by known methods from the corresponding alcohols R¹—OH and ethylene or alkylene oxide. Residue R¹ in the above formula may vary depending on the origin of the alcohol. If natural sources are used, the residue R¹ comprises an even number of carbon atoms and is generally unbranched, preference being given to linear residues from alcohols of natural origin with 12 to 18 C atoms, for example from coconut, palm, tallow fat or oleyl alcohol. Alcohols obtainable from synthetic sources are for example Guerbet alcohols or residues methyl-branched in position 2 or linear and methyl-branched residues in a mixture as they are conventionally present in oxo alcohol residues. Irrespective of the nature of the alcohol used for producing nonionic surfactants contained in the agent, preferred nonionic surfactants are those in which R¹ in the above formula denotes an alkyl residue with 6 to 24, preferably 8 to 20, particularly preferably 9 to 15 and in particular 9 to 11 carbon atoms.

Apart from propylene oxide, butylene oxide may in particular be considered as the alkylene oxide unit which alternates with the ethylene oxide unit in preferred nonionic surfactants. However, further alkylene oxides, in which R² or R³ are mutually independently selected from —CH₂CH₂—CH₃ or —CH(CH₃)₂ are also suitable. Nonionic surfactants of the above formula which are preferably used are those in which R² or R³ denotes a residue —CH₃, w and x mutually independently denote values of 3 or 4 and y and z mutually independently denote values of 1 or 2.

In summary, preferred nonionic surfactants are in particular those which comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)_{w}-(A′O)ₓ-(A″O)_{y}-(A′″O)_{z}—R², in which R¹ and R² mutually independently denote a straight-chain or branched, saturated or mono- or polyunsaturated C₂₋₄₀ alkyl or alkenyl residue; A, A′, A″ and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z denote values between 0.5 and 90, with x, y and/or z possibly also being 0, are preferred according to the invention.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants are those of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15.

Particularly preferred end group-terminated poly(oxyalkylated) nonionic surfactants are furthermore those of the formula R¹O[CH₂CH₂O]ₓ[CH₂CH(R³)O]_{y}CH₂CH(OH)R², in which R¹ and R² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, with nonionic surfactants with R³=—CH₃ and values of x from 15 to 32 and y from 0.5 and 1.5 being very particularly preferred.

Further preferably usable nonionic surfactants are the end group-terminated poly(oxyalkylated) nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues with 1 to 30 carbon atoms, R³ denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value of x is ≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH₃ or —CH₂CH₃ are particularly preferred for the residue R³. Particularly preferred values for x are in the range from 1 to 20, in particular from 6 to 15.

As described above, each R³ in the above formula may be different if x is ≧2. In this manner, it is possible to vary the alkylene oxide unit in the square brackets. For example, if x denotes 3, the residue R³ may be selected in order to form ethylene oxide (R³═H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, the range of variation increasing as the value of x rises and for example comprising a large number of (EO) groups combined with a small number of (PO) groups, or vice versa.

Particularly preferred end group-terminated poly(oxyalkylated) alcohols of the above-stated formula have values of k=1 and j=1, so simplifying the above formula to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those in which the residues R¹ and R² comprise 9 to 14 C atoms, R³ denotes H and x assumes values from 6 to 15.

The stated C chain lengths and degrees of ethoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various ones of the above-stated general formulae.

In the detergent or cleaning agent portions according to the invention, the first dosing unit is combined with a second water-soluble dosing unit which differs from the first and comprises a second detergent or cleaning agent preparation. The second dosing unit is preferably selected from pouches, dimensionally stable containers and moldings. In one particularly preferred embodiment of the invention, the second dosing unit is a molding which comprises at least one press-molded phase, but may alternatively also comprise two or more press-molded phases. In particular, the second dosing unit may be a molding with at least one press-molded phase, the molding comprising an indentation or hollow. The indentation may also be constructed such that it extends from a first surface of the molding to a second, opposing surface of the molding. In one particular embodiment, the indentation may take the form of a cylindrical bore or recess which extends through the molding.

In a further embodiment of the invention, the second dosing unit is an injection-molded container or molding.

In a detergent or cleaning agent portion according to the invention, the first dosing unit may be loosely combined with the second dosing unit and for example be present in a common water-soluble or water-insoluble outer packaging, but they may also be joined together to form a common combination product.

It is, however, preferred according to the invention for the two dosing units to be joined together to form a common combination product and for the first dosing unit and the second dosing unit to be joined by means of an adhesive, latching, snap-fit or plug-in joint, in particular with an adhesive or plug-in joint.

Particularly preferred portions are those in which the first dosing unit is at least in part arranged in an indentation of the second dosing unit. Accordingly, the second dosing unit may for example be a tablet with an indentation, into which the container of the first dosing unit is at least in part fitted. The tablet may here, for example, take the form of an indented tablet or annular tablet. In one particular embodiment, the tablet and the container are joined by an adhesive joint, for example the container of the first dosing unit may be adhesively bonded in the indentation of the second dosing unit.

In such an embodiment, particularly preferred detergent or cleaning agent portions are in particular those in which the container of the first dosing unit is fitted into an indentation, for example a hollow or hole or recess of the tablet, in such a manner that an optionally present sealed or pinch-off seam on the container is completely hidden in the hollow or hole or recess of the molding and in this manner removed from the effects of direct mechanical action, for example due to impact or dropping.

In a further preferred embodiment of a detergent or cleaning agent portion according to the invention, the first dosing unit is partially arranged in an indentation of the second dosing unit such that, in the part of the first dosing unit arranged in the indentation, the area-averaged thickness of the container wall is greater than in the part of the container of the first dosing unit which is not arranged in the indentation. This embodiment is for example particularly advantageous when the first dosing unit is to be adhesively bonded in the indentation of the second dosing unit because the container wall then has elevated mechanical stability in the bond area, without the solubility of the container wall outside the bond area and thus the release rate of the container's contents being impaired when the portion is used.

In a likewise preferred embodiment of a detergent or cleaning agent portion according to the invention, the container of the first dosing unit comprises a peripheral sealed or pinch-off seam and is non-interlockingly or frictionally joined by said seam to the second dosing unit.

In a particularly preferred embodiment, the peripheral sealed or pinch-off seam is located for this purpose in the area of the largest circumference of the container and preferably projects therebeyond by up to 3 mm, in particular by up to 2 mm. The container is here introduced into an indentation of the second dosing unit, the indentation having a smaller cross-section than the area described by the peripheral sealed or pinch-off seam of the container before it is joined to the second dosing unit. One particular example of this embodiment is a first dosing unit consisting of a rotationally symmetrical, in particular spherical, container which comprises a radially projecting pinch-off seam in the area of its great circle which surrounds the container in the manner of one of “Saturn's rings”. If this first dosing unit is now introduced for example into a tablet with a cylindrical through-hole or recess, which may also be described as an “annular tablet” or “perforated tablet”, it being necessary for the cross-section of the through-hole or recess to be somewhat smaller than the original cross-section of the container including the pinch-off seam before introduction into the tablet, the container can be frictionally fixed in the tablet by simply being inserted, without for example requiring an adhesive.

In a further preferred embodiment of a detergent or cleaning agent portion according to the invention, the first dosing unit is combined with a second dosing unit in the form of a filled water-soluble pouch or container. The first dosing unit may in turn be combined loosely with the water-soluble pouches or containers, the two dosing units possibly being present in a common water-soluble or water-insoluble outer packaging. Alternatively and, in the present case, particularly preferably, the first dosing unit is, however, integrated into the second dosing unit. The first dosing unit may, for example, be placed in a pouch or container filled with a solid and/or liquid detergent or cleaning agent preparation or be joined to such a pouch or container, for example by means of an adhesive, latching, snap-fit or plug-in mechanism.

Particularly preferred detergent or cleaning agent portions according to the invention are those which are characterized in that, at a specific temperature, in particular in the range from 10 to 20° C., the first dosing unit is more rapidly soluble in water than the second dosing unit. The dissolution rate may be determined by the “Sotax dissolution method” which is described in the literature, for example on page 3 of EP-B1 960187.

The detergent or cleaning agent portions according to the invention are particularly preferentially suitable for dosing detergents or cleaning agents in the machine washing of textiles or crockery. The portions according to the invention may here be used both alone and in combination with other dosing units.

The detergent or cleaning agent portions according to the invention may for example be offered for sale packaged in water-insoluble containers. These water-insoluble containers may, for example, comprise pouches, cartons or boxes, in which the portions are packaged in sorted or loose manner. In a preferred embodiment, the water-insoluble packaging comprises a dosing device with which the consumer can separate out the portions and preferably dispense them in targeted manner, for example into the dosing chamber of a washing machine or a dishwashing machine.

The detergent or cleaning agent portions according to the invention may in principle be produced by a combination of method steps according to the prior art.

A preferred method according to the invention comprises the steps
a) forming a hollow article of a water-soluble polymeric material
b) filling the hollow article with a first liquid detergent or cleaning agent preparation and a gas in such a manner that a gas space remains in the hollow article which is under a pressure of at least 1.02 bar
c) sealing the hollow article in fluid-tight manner
d) assembling the first dosing unit formed in this manner with a second water-soluble dosing unit which differs from the first and comprises a second detergent or cleaning agent preparation.

The hollow article is particularly preferably formed in step a) by blow molding, in particular by extrusion blow molding.

In a particularly preferred embodiment, a hollow article is formed from a water-soluble polymeric material in step a), the hollow article is filled with a first liquid detergent or cleaning agent preparation in step b) and the hollow article is sealed in fluid-tight manner in step c) in the manner as is known from Rommelag's blow/fill/seal (BFS) technology, which is also known as “Bottelpack®” technology.

Further suitable embodiments of production methods, as may also be used in the present invention, may for example be found in document DE 10244802.

The pressure may be established in step b) of the method according to the invention in various ways. In a preferred embodiment, it is established such that the initially air-filled hollow article produced in step a) is filled in step b) with the liquid preparation via a filling mandrel which seals tightly with the opening to the hollow article and subsequent fluid-tight sealing of the hollow article also proceeds in such a manner that the air displaced by the liquid in the hollow article cannot escape via the opening to the hollow article. However, the pressure may also be established in step b) of the method according to the invention, for example, by addition of a chilled gas, as is described in DE 10244802.

Particularly preferred methods, as described above, are those in which the second dosing unit is a molding with at least one press-molded phase, and in which in particular the at least one press-molded phase comprises an indentation.

In a very particularly preferred embodiment of a production method according to the invention, the first dosage unit is assembled with the second in step d) of the method such that the first dosing unit is inserted into or adhesively bonded in the indentation.

In addition to the container, the first dosing unit of a detergent or cleaning agent portion according to the invention comprises a liquid detergent or cleaning agent preparation.

The liquid detergent or cleaning agent preparation may be of low-viscosity to viscous. For the purposes of the present invention, “liquid” here preferably describes such agents which are flowable in a temperature range between 10 and 40° C., in particular at 20° C., and atmospheric pressure (1.013 bar) and can run out of containers under the action of gravity. The viscosity (Brookfield LVT-II viscosimeter at 20 rpm and 20° C., spindle 3) of the detergent or cleaning agent preparations preferably amounts to between 10 and 10000 mPa·s, particularly preferably between 50 and 5000 mPa·s, and in particular between 100 and 2000 mPa·s.

The liquid detergent or cleaning agent preparation preferably comprises a solution, a suspension or an emulsion. Solvents or dispersants other than water which may be considered are also nonaqueous, organic solvents.

The organic solvents preferably originate from the groups of monoalcohols, diols, triols or polyols, ethers, esters and/or amides. Particularly preferred organic solvents are those which are water-soluble, “water-soluble” solvents for the purposes of the present application being those solvents which are completely miscible, i.e. without a miscibility gap, with water at room temperature.

Organic solvents which may be used in the preparations according to the invention preferably originate from the group of mono- or polyhydric alcohols, alkanolamines or glycol ethers, provided that they are water-miscible in the stated concentration range. The solvents are preferably selected from ethanol, n- or i-propanol, butanols, glycol, propane- or butanediol, glycerol, diglycol, diethylene glycol monopropyl or monobutyl ether, hexylene glycol, ethylene glycol methyl ether, ethylene glycol ethyl ether, ethylene glycol propyl ether, ethylene glycol n-butyl ether, diethylene glycol methyl ether, diethylene glycol ethyl ether, propylene glycol methyl, ethyl or propyl ether, dipropylene glycol methyl or ethyl ether, methoxy, ethoxy or butoxytriglycol, 1-butoxyethoxy-2-propanol, 3-methyl-3-methoxybutanol, propylene glycol t-butyl ether and mixtures of these solvents.

If the liquid detergent or cleaning agent preparation present in the container assumes the form of a suspension, the size of the particles present in the dispersant is preferably restricted. In a first embodiment, the suspended particles preferably have a size of below 500 μm, preferably of below 300 μm and in particular of below 100 μm. In a second embodiment, the size of the suspended particles amounts to between 1 and 30 mm, preferably between 2 and 20 mm and in particular between 3 and 15 mm.

The detergent or cleaning agent preparations contained in the two dosing units of a detergent or cleaning agent portion according to the invention in each case mutually independently contain at least one substance with a detergent or cleaning action or a mixture of substances, the substance with a detergent or cleaning action preferably being selected from the group of surfactants, builders, polymers, bleaching agents, bleaching activators, enzymes, glass corrosion inhibitors, corrosion inhibitors, disintegration auxiliaries, fragrances and perfume carriers, dyes and mixtures thereof, it being possible to select the respectively suitable substances for detergents or cleaning agents according to the prior art, this posing no difficulties for a person skilled in the relevant art.

In addition to these substances, the detergent or cleaning agent preparations may contain further ingredients which further enhance the applicational and/or aesthetic properties of these agents. Preferred preparations contain one or more substances from the group of electrolytes, pH adjusting agents, fluorescent agents, hydrotropes, foam inhibitors, silicone oils, antiredeposition agents, optical brighteners, graying inhibitors, shrinkage prevention agents, anti-crease agents, dye transfer inhibitors, antimicrobial active ingredients, germicides, fungicides, antioxidants, antistatic agents, ironing aids, waterproofing and impregnation agents, anti-swelling and anti-slip agents and UV absorbers.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

While particular embodiments of the present invention have been illustrated and described, it would be obvious to those skilled in the art that various other changes and modifications can be made without departing from the spirit and scope of the invention. Changes in form and substitution of equivalents are contemplated as circumstances may suggest or render expedient. Although specific terms have been employed herein, such terms are intended in a descriptive sense and not for purposes of limitation. It is understood that the embodiments described herein are for illustrative purposes only and that various modifications or changes will be suggested to one skilled in the art without departing from the scope of the present invention. The appended claims therefore are intended to cover all such changes and modifications that are within the scope of this invention.

What is claimed:

1. A detergent or cleaning agent portion comprising:
a) a first dosing unit comprising a completely sealed water-soluble container comprising a transparent or translucent polymeric material and, enclosed in the container, a first detergent or cleaning agent preparation that is liquid and occupies up to 99% by volume of the container, the container furthermore containing a gas under a pressure of at least 1.02 bar that occupies at least 1% by volume of the container; and
b) a second water-soluble dosing unit, different from the first dosing unit, comprising a second detergent or cleaning agent preparation.

2. The detergent or cleaning agent portion of claim 1, wherein the polymeric material comprising the container Wall is thicker in a first subzone of the container surface than in a second subzone.

3. The detergent or cleaning agent portion of claim 1, wherein the container comprises a peripheral sealed or pinch-off seam with a width of less than 3 mm.

4. The detergent or cleaning agent portion of claim 3, wherein the sealed or pinch-off seam subdivides the surface of the container into two subareas of different sizes.

5. The detergent or cleaning agent portion of claim 1, wherein the second dosing unit comprises a pouch, a dimensionally stable container, or a molding.

6. The detergent or cleaning agent portion of claim 5, wherein the molding comprises at least one press-molded phase.

7. The detergent or cleaning agent portion of claim 1, wherein the first dosing unit is joined to the second dosing unit by means of an adhesive, latching, snap-fit, or plug-in joint.

8. The detergent or cleaning agent portion of claim 1, wherein the first dosing unit is at least partially arranged in an indentation of the second dosing unit.

9. The detergent or cleaning agent portion of claim 8, wherein the first dosing unit is partially arranged in an indentation of the second dosing unit and the part of the first dosing unit arranged in the indentation has an area-averaged thickness of the container wall greater than in the part of the container of the first dosing unit that is not arranged in the indentation.

10. The detergent or cleaning agent portion of claim 9, wherein the container of the first dosing unit comprises a peripheral sealed or pinch-off seam and is non-interlockingly or frictionally joined by said seam to the second dosing unit.

11. A method of machine washing textiles or crockery comprising dosing the detergent or cleaning agent portion of claim 1 into a machine washing process for textiles or crockery.

12. A method for the production of a detergent or cleaning agent portion of claim 1, comprising the steps of:
a) forming a hollow article of a water-soluble polymeric material;
b) filling the hollow article with a first liquid detergent or cleaning agent preparation and a gas in such a manner that a gas space remains in the hollow article which is under a pressure of at least 1.02 bar;
c) sealing the hollow article in fluid-tight manner; and
d) assembling the first dosing unit with a second water-soluble dosing unit that differs from the first and comprises a second detergent or cleaning agent preparation.

13. The method of claim 12, wherein the second dosing unit is a molding having at least one press-molded phase.

14. The method of claim 13, wherein the at least one press-molded phase comprises an indentation.

15. The method of claim 14, wherein the first dosage unit is assembled with the second in step d) such that the first dosing unit is inserted into or adhesively bonded in the indentation.

16. The detergent or cleaning agent portion of claim 3, wherein the container comprises a peripheral sealed or pinch-off seam with a width of less than 2 mm.

17. The detergent or cleaning agent portion of claim 16, wherein the container comprises a peripheral sealed or pinch-off seam with a width of less than 1 mm.

18. The detergent or cleaning agent portion of claim 7, wherein the first dosing unit is joined to the second dosing unit by means of a plug-in or adhesive joint.
